(19) United States
(12) Patent Application Publication
(10) Pub. No.: US 2026/0316618 A1
(43) Pub. Date: Oct. 15, 2026

(54) VEHICLE CHARGING SYSTEM, METHOD AND APPARATUS, AND DEVICE AND STORAGE MEDIUM

(71) Applicant: CHINA UNIONPAY CO., LTD., Shanghai (CN)

(72) Inventors: Wenbin QI, Shanghai (CN); Jin QIAN, Shanghai (CN); Wangnian ZENG, Shanghai (CN); Quan SUN, Shanghai (CN); Yang YANG, Shanghai (CN)

(21) Appl. No.: 19/486,183

(22) PCT Filed: Mar. 22, 2024
(86) PCT No.: PCT/CN2024/083404

§ 371 Date: Nov. 20, 2025

(30) Foreign Application Priority Data
May 31, 2023 (CN) 202310634328.8

(51) Int. Cl. B60L 53/66; B60L 53/16

(52) U.S. Cl. CPC B60L 53/66; B60L 53/16

(57) ABSTRACT

A vehicle charging system enables accurate matching between a vehicle and a charging gun. When a vehicle unlocks its charging port, it sends its parking space identifier to a vehicle server, and upon detecting gun insertion, it also sends a first timestamp. The charging pile server reports the charging gun identifier and a second timestamp when a gun is inserted. The vehicle server cross-references the parking space with pre-stored mappings of candidate guns and compares the first and second timestamps. If exactly one gun matches within a set time threshold, the server issues a charging command to the charging pile server. The pile server then sends a charging instruction to the identified gun, which in turn initiates charging for the connected vehicle.

### CROSS-REFERENCE TO RELATED APPLICATIONS

This application claims priority to the Chinese patent application filed with the State Intellectual Property Office of China on May 31, 2023, with application No. 202310634328.8 and application title “VEHICLE CHARGING SYSTEM, METHOD, APPARATUS, DEVICE AND STORAGE MEDIUM”, the entire content of which is incorporated by reference into this application.

### FIELD OF THE DISCLOSURE

The present disclosure generally relates to the field of vehicle charging technology, and in particular to a vehicle charging system, method, apparatus, device and storage medium.

### BACKGROUND

When using charging piles in shopping districts and other places to charge new energy vehicles and other vehicles, a relatively advanced method is to replace the traditional QR code scanning charging by identifying the parking space number of the vehicle. That is, after a vehicle detects an event of inserting a charging gun on a charging pile into the vehicle's charging port, the parking space number of the parking space may be intelligently identified, so that the shopping district server may find the corresponding charging pile based on the parking space number, and then the corresponding charging pile server may send a charging command to the charging pile, thereby realizing the process of charging the vehicle using the charging gun on the charging pile.

However, the above solution only works when there's a one-to-one correspondence between parking spaces and charging guns. Currently, only about 5% of parking spaces at charging stations have a one-to-one correspondence with charging guns. Most stations have two or three charging guns on a charging pile, and multiple charging guns are available for a single parking space. If this solution is still used, charging failures or incorrect fund deductions may occur. Therefore, a technical solution that can quickly and accurately charge vehicles is urgently needed.

### SUMMARY

The present disclosure provides a vehicle charging system, method, apparatus, device and storage medium for quickly and accurately charging a vehicle.

In a first aspect, the present disclosure provides a vehicle charging system, and the system includes: a vehicle, configured to send a target parking space identifier of a parking space where the vehicle is located to a vehicle server when an intention-to-charge event showing a charging port being unlocked is detected, and send a first timestamp to the vehicle server if the charging port is detected as being inserted with a charging gun; a charging pile server, configured to, if any charging gun is detected as being inserted into one charging port, send a charging gun identifier of that charging gun and a corresponding second timestamp to the vehicle server; the vehicle server, configured to receive the target parking space identifier, determine candidate charging gun identifiers corresponding to the target parking space identifier based on a pre-stored correspondence between parking space identifiers and charging gun identifiers, receive charging gun identifiers and corresponding second timestamps, and if it is determined that, among all candidate charging gun identifiers corresponding to the target parking space identifier, there is only one that corresponds to a second timestamp whose time difference with the first timestamp is less than a time threshold, send a charging command to the charging pile server, where the charging command carries a target charging gun identifier corresponding to a second timestamp whose time difference is less than the time threshold, where the charging pile server is further configured to receive the charging command and send a charging instruction to a charging gun corresponding to the target charging gun identifier; and the charging gun corresponding to the target charging gun identifier, configured to receive the charging instruction and charge a connected vehicle.

In a second aspect, the present disclosure provides a vehicle charging method, which is applied to a vehicle server and includes: when a target parking space identifier is received from a vehicle, determining candidate charging gun identifiers corresponding to the target parking space identifier according to a pre-stored correspondence between parking space identifiers and charging gun identifiers; and when a first timestamp sent by the vehicle, charging gun identifiers and corresponding second timestamps sent by a charging pile server are received, and when it is determined that, among all candidate charging gun identifiers corresponding to the target parking space identifier, there is only one that corresponds to a second timestamp whose time difference with the first timestamp is less than a time threshold, sending a charging command to the charging pile server, where the charging command carries a target charging gun identifier corresponding to a second timestamp whose time difference is less than the time threshold, enabling the charging pile server to send a charging instruction to a charging gun corresponding to the target charging gun identifier, and enabling the charging gun corresponding to the target charging gun identifier to charge a vehicle connected to itself, where the first timestamp is sent by the vehicle when the vehicle detects that a charging port is being inserted with a charging gun, and the charging gun identifiers and the corresponding second timestamps include a charging gun identifier of any charging gun and a corresponding second timestamp sent by the charging pile server when that charging gun is detected as being inserted into one charging port.

In a third aspect, the present disclosure provides a vehicle charging method, which is applied to a vehicle and includes: when an intention-to-charge event showing a charging port being unlocked is detected, sending a target parking space identifier of a parking space where the vehicle is located to a vehicle server; and when the charging port is detected as being inserted with a charging gun, sending a first timestamp to the vehicle server, where the vehicle server determines candidate charging gun identifiers corresponding to the target parking space identifier based on a pre-stored correspondence between parking space identifiers and charging gun identifiers, the vehicle server receives charging gun identifiers and corresponding second timestamps sent by a charging pile server, and when the vehicle server determines that among the candidate charging gun identifiers corresponding to the target parking space identifier, there is only one that corresponds to a second timestamp whose time difference with the first timestamp is less than a time threshold, the vehicle server sends a charging command to the charging pile server, where the charging command carries a target charging gun identifier corresponding to a second timestamp whose time difference is less than the time threshold, the charging pile server sends a charging instruction to a charging gun corresponding to the target charging gun identifier, and the charging gun corresponding to the target charging gun identifier charges a vehicle connected to itself, where the charging gun identifiers and the corresponding second timestamps received by the vehicle server include a charging gun identifier of any charging gun and a corresponding second timestamp sent by the charging pile server when that charging gun is detected as being inserted into a charging port.

In a fourth aspect, the present disclosure provides a vehicle charging method, which is applied to a charging pile server, and the method includes: when any charging gun is detected as being inserted into one charging port, sending a charging gun identifier of that charging gun and a corresponding second timestamp to a vehicle server, so that when the vehicle server determines that, among all candidate charging gun identifiers corresponding to a target parking space identifier, there is only one that corresponds to a second timestamp whose time difference with a first timestamp is less than a time threshold, a charging command is sent to the charging pile server, and the charging command carries a target charging gun identifier corresponding to a second timestamp whose time difference is less than the time threshold, where the target parking space identifier is a parking space identifier, of a parking space where a vehicle is located, sent by the vehicle to the vehicle server, and the first timestamp is sent by the vehicle to the vehicle server when a charging port is detected as being inserted with a charging gun; and receiving the charging command and sending a charging instruction to a charging gun corresponding to the target charging connector identifier, so that the charging gun charges a vehicle connected to itself.

In a fifth aspect, the present disclosure provides a vehicle charging apparatus, which is applied to a vehicle server and includes: a determination module, configured to, upon receiving a target parking space identifier sent by a vehicle, determine candidate charging gun identifiers corresponding to the target parking space identifier based on a pre-stored correspondence between parking space identifiers and charging gun identifiers; and a charging module, configured to send a charging command to a charging pile server if it receives a first timestamp sent by the vehicle, charging gun identifiers and corresponding second timestamps sent by the charging pile server, and determine that, among all candidate charging gun identifiers corresponding to the target parking space identifier, there is only one that corresponds to a second timestamp whose time difference with the first timestamp is less than a time threshold, where the charging command carries a target charging gun identifier corresponding to a second timestamp whose time difference is less than the time threshold, enable the charging pile server to send a charging instruction to a charging gun corresponding to the target charging gun identifier, and enable the charging gun corresponding to the target charging gun identifier to charge a vehicle connected to itself, where the first timestamp is sent by the vehicle when the vehicle detects that a charging port is being inserted with a charging gun, and the charging gun identifiers and the corresponding second timestamps received by the vehicle server include a charging gun identifier of any charging gun and a corresponding second timestamp sent by the charging pile server when that charging gun is detected as being inserted into a charging port.

In a sixth aspect, the present disclosure provides a vehicle charging apparatus, which is applied to a vehicle and includes: a first transmission module, configured to send a target parking space identifier of a parking space where the vehicle is located to a vehicle server upon detecting an intention-to-charge event showing a charging port being unlocked; and a second transmission module, configured to send a first timestamp to the vehicle server when the charging port is detected as being inserted with a charging gun, enable the vehicle server to determine candidate charging gun identifiers corresponding to the target parking space identifier based on a pre-stored correspondence between parking space identifiers and charging gun identifiers, enable the vehicle server to receive charging gun identifiers and corresponding second timestamps sent by a charging pile server, and enable the vehicle server to send a charging command to the charging pile server when it is determined that, among the candidate charging gun identifiers corresponding to the target parking space identifier, there is only one that corresponds to a second timestamp whose time difference with a first timestamp is less than a time threshold, where the charging command carries a target charging gun identifier corresponding to a second timestamp whose time difference is less than the time threshold, enable the charging pile server to send a charging instruction to a charging gun corresponding to the target charging gun identifier, and enable the charging gun corresponding to the target charging gun identifier to charge a vehicle connected to itself, where the charging gun identifiers and the corresponding second timestamps received by the vehicle server include a charging gun identifier of any charging gun and a corresponding second timestamp sent by the charging pile server when that charging gun is detected as being inserted into a charging port.

In a seventh aspect, the present disclosure provides a vehicle charging apparatus, which is applied to a charging pile server, and includes: a third transmission module, configured to send a charging gun identifier of any charging gun and a corresponding second timestamp to a vehicle server if that charging gun is detected as being inserted into a charging port, so that if the vehicle server determines that, among all candidate charging gun identifiers corresponding to a target parking space identifier, there is only one that corresponds to a second timestamp whose time difference with a first timestamp is less than a time threshold, the vehicle server sends a charging command to a charging pile server, and the charging command carries a target charging gun identifier corresponding to a second timestamp whose time difference is less than the time threshold, where the target parking space identifier is a parking space identifier, of a parking space where a vehicle is located, sent by the vehicle to the vehicle server, and the first timestamp is sent by the vehicle to the vehicle server when a charging port is detected as being inserted with a charging gun; and an instruction module, configured to receive the charging command and send a charging instruction to a charging gun corresponding to the target charging gun identifier, so that the charging gun corresponding to the target charging gun identifier charges the vehicle connected to itself.

In an eighth aspect, the present disclosure provides an electronic device, which includes at least a processor and a memory, and the processor is configured to implement the steps of any of the above methods when executing a computer program stored in the memory.

In a ninth aspect, the present disclosure provides a computer-readable storage medium storing a computer program, which implements the steps of any of the above methods when executed by a processor.

In the embodiments of the present disclosure, if a vehicle detects an intention-to-charge event showing the charging port being unlocked, the vehicle sends a target parking space identifier of the parking space where the vehicle is located to the vehicle server. When the vehicle detects that the charging port is being inserted with a charging gun, the vehicle may send a first timestamp to the vehicle server. The charging pile server may send the charging gun identifier and the corresponding second timestamp of any charging gun to the vehicle server when it is detected that there is any charging gun being inserted into a charging port. After the vehicle server receives the target parking space identifier, the vehicle server may determine the candidate charging gun identifiers corresponding to the target parking space identifier based on a pre-stored correspondence between parking space identifiers and charging gun identifiers. After receiving the first timestamp, charging gun identifiers and corresponding second timestamps, if it is determined that among the candidate charging gun identifiers corresponding to the target parking space identifier, there is only one that corresponds to a second timestamp whose time difference with the first timestamp is less than a time threshold, a charging command is sent to the charging pile server, where the charging command carries a target charging gun identifier corresponding to the second timestamp whose time difference is less than the time threshold. After receiving the charging command, the charging pile server may send a charging instruction to a charging gun corresponding to the target charging gun identifier. After receiving the charging instruction, the charging gun corresponding to the target charging gun identifier may charge the vehicle connected to itself. Since the present disclosure may determine that, among all candidate charging gun identifiers corresponding to the target parking space identifier, there is only one that corresponds to a second timestamp whose time difference with the first timestamp is less than the time threshold, the charging gun identifier corresponding to the unique second timestamp whose time difference is less than the time threshold is considered the target charging gun identifier, and a charging command carrying the target charging gun identifier is sent to the charging pile server. Based on this, the purpose of quickly and accurately charging the vehicle may be achieved.

### BRIEF DESCRIPTION OF THE DRAWINGS

In order to more clearly illustrate embodiments of the present disclosure or implementations in the related technologies, the following is a brief introduction to the drawings essential for descriptions of the embodiments or related technology. Apparently, the drawings described below are some embodiments of the present disclosure. For a person skilled in the art, other drawings may also be obtained based on these drawings.

FIG. 1 shows a schematic diagram of a vehicle charging system in accordance with some embodiments;

FIG. 2 shows a schematic diagram of a first vehicle charging process in accordance with some embodiments;

FIG. 3 shows a schematic diagram of a second vehicle charging process in accordance with some embodiments;

FIG. 4 shows a schematic diagram of a third vehicle charging process in accordance with some embodiments;

FIG. 5 shows a schematic diagram of a fourth vehicle charging process in accordance with some embodiments;

FIG. 6 shows a schematic diagram of a fifth vehicle charging process in accordance with some embodiments;

FIG. 7 shows a schematic diagram of a sixth vehicle charging process in accordance with some embodiments;

FIG. 8 shows a schematic diagram of a seventh vehicle charging process in accordance with some embodiments;

FIG. 9 shows a schematic diagram of an eighth vehicle charging process in accordance with some embodiments;

FIG. 10 shows a schematic diagram of a first vehicle charging apparatus in accordance with some embodiments;

FIG. 11 shows a schematic diagram of a second vehicle charging apparatus in accordance with some embodiments;

FIG. 12 shows a schematic diagram of a third vehicle charging apparatus in accordance with some embodiments; and

FIG. 13 shows a schematic structural diagram of an electronic device in accordance with some embodiments.

### DETAILED DESCRIPTION

In order to charge a vehicle quickly and accurately, the present disclosure provides a vehicle charging system, method, apparatus, device and storage medium.

In order to make the purposes and implementations of the present disclosure clearer, the exemplary embodiments of the present disclosure will be clearly and thoroughly described below in conjunction with the drawings in the exemplary embodiments of the present disclosure. Apparently, the described exemplary embodiments are just part of the embodiments of the present disclosure, but not all of the embodiments.

It should be noted that the brief descriptions of terms in the present disclosure are merely for the purpose of facilitating the understanding of the embodiments described below, and are not intended to limit the embodiments of the present disclosure. Unless otherwise specified, these terms should be understood according to their general and ordinary meanings.

In the specification and claims of the present disclosure and the accompanying drawings, the terms “first”, “second”, “third”, etc., are used to distinguish similar or identical objects or entities, and are not necessarily intended to limit a particular order or sequence, unless otherwise noted. It should be understood that the terms used in this manner are interchangeable under appropriate circumstances.

The terms “comprise”, “include”, and “comprising”, and any variations thereof, are intended to cover a non-exclusive inclusion. For example, a product or device comprising a list of components is not necessarily limited to all the components expressly listed, but may include other components not expressly listed or inherent to such product or device.

The term “module” refers to any known or later developed hardware, software, firmware, artificial intelligence, fuzzy logic, or combination of hardware and/or software code that is capable of performing the functionality associated with that element.

Finally, it should be noted that the above embodiments are merely used to illustrate the technical solutions of the present disclosure, rather than to limit these solutions. Although the present disclosure is described in detail with reference to these embodiments, those skilled in the art should understand that they may still modify the technical solutions described in these embodiments or make equivalent replacements for some or all the technical features therein. These modifications or replacements do not deviate the essence of the corresponding technical solutions from the scope of the technical solutions of the embodiments of the present disclosure.

All implementations of the embodiments of the present disclosure regarding the acquisition, storage, use, and processing of data comply with the relevant provisions of national laws and regulations.

### Embodiment 1

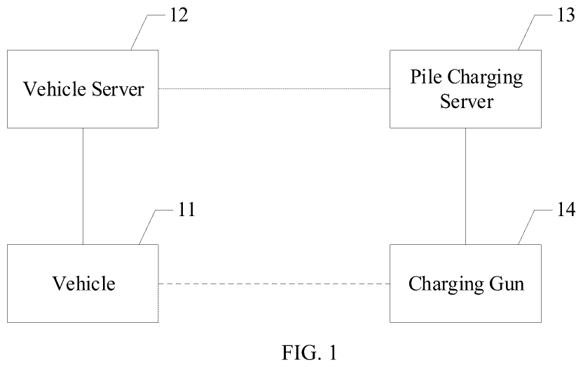

FIG. 1 shows a schematic diagram of a vehicle charging system in accordance with some embodiments. As shown in FIG. 1, the system includes:

A vehicle 11, configured to send a target parking space identifier of a parking space where the vehicle is located to a vehicle server 12 if the vehicle detects an intention-to-charge event showing the charging port being unlocked, and send a first timestamp to the vehicle server if the charging port is detected as being inserted with a charging gun.

A charging pile server 13, configured to, if any charging gun is detected as being inserted into a charging port, send a charging gun identifier of that charging gun and a corresponding second timestamp to the vehicle server 12.

The vehicle server 12, configured to receive the target parking space identifier and determine candidate charging gun identifiers corresponding to the target parking space identifier based on a pre-stored correspondence between parking space identifiers and charging gun identifiers, receive charging gun identifiers and the corresponding second timestamps, and if it is determined that, among all candidate charging gun identifiers corresponding to the target parking space identifier, there is only one that corresponds to a second timestamp whose time difference with the first timestamp is less than a time threshold, send a charging command to the charging pile server 13, where the charging command carries a target charging gun identifier corresponding to a second timestamp whose time difference is less than the time threshold.

The charging pile server 13, further configured to receive the charging command and send a charging instruction to a charging gun 14 corresponding to the target charging gun identifier.

The charging gun 14 corresponding to the target charging gun identifier, configured to receive the charging instruction and charge a vehicle connected to the charging gun.

In one possible implementation, when the vehicle 11 parks in a parking space in a commercial district parking lot by backing into a garage, the vehicle 11 (also referred to as the vehicle-mounted subsystem) may intelligently acquire a target parking space identifier located on the ground, etc., by activating a 360-degree panoramic imaging assistance system within the vehicle. For example, when the vehicle 11 parks in the parking space by backing into the garage, the vehicle (or vehicle-mounted subsystem) may automatically activate a 360-degree panoramic imaging assistance system within the vehicle. This 360-degree panoramic imaging assistance system may utilize image acquisition modules, such as cameras located in the vehicle's front and rearview mirrors, to simulate a corresponding bird's-eye view through a configured algorithm, thereby intelligently detecting the ground conditions near the parking space and acquiring the target parking space identifier for the vehicle's parking space. The target parking space identifier (parking space identifier) may be flexibly designed as needed. For example, the target parking space identifier may be a digital parking space identifier, or may be a letter, one-dimensional code, or two-dimensional code identifier, etc., which is not specifically limited in the present disclosure. The target parking space identifier may be acquired using existing techniques and will not be further described here.

In one possible implementation, when the vehicle 11 needs to be charged, the owner may trigger an intention-to-charge event showing the charging port being unlocked by popping out the charging cover, etc. After the vehicle 11 detects the intention-to-charge event, the vehicle may send the obtained target parking space identifier of the parking space where the vehicle is located to the vehicle server 12 (also referred to as the backend server). Optionally, an application (App) that allows users to pay for charging fees through contactless payment may be pre-installed in the vehicle 11 (vehicle-mounted subsystem). This application may be unrelated to the brand of a charging pile, a business district, etc. In other words, in order to avoid the need to install different apps for different brands of charging piles, different business districts, etc., the vehicle 11 (vehicle-mounted subsystem) of the present disclosure may just install one App for paying for charging fees through contactless payment. Through this App, the target parking space identifier of the parking space where the vehicle 11 is located may be sent to the vehicle server 12. In addition, the present disclosure does not impose any specific restrictions on the timing of obtaining the target parking space identifier. For example, the target parking space identifier of the vehicle's parking space may be obtained (identified) when the vehicle 11 parks in the parking space, or the target parking space identifier of the vehicle's parking space may be obtained when an intention-to-charge event showing the charging port being unlocked is detected. The present disclosure does not impose any specific restrictions on the order of identifying the target parking space identifier and detecting the intention-to-charge event, and this order may be flexibly set according to needs.

In one possible implementation, after the vehicle 11 sends the target parking space identifier to the vehicle server 12, the vehicle server 12 may receive the target parking space identifier and determine candidate charging gun identifiers corresponding to the target parking space identifier based on a pre-stored correspondence between parking space identifiers and charging gun identifiers. The present disclosure does not specifically limit the number of candidate charging gun identifiers corresponding to the target parking space identifier, which may be one or more. In addition, the candidate charging guns may be charging guns on a same charging pile or charging guns on different charging piles, etc., which is not specifically limited in the present disclosure.

In one possible implementation, when the car owner inserts a charging gun into the vehicle's charging port, the vehicle 11 may detect that a charging gun is being inserted into its own charging port, and then obtain a timestamp of the charging gun being inserted into the charging port (referred to as the first timestamp for ease of description), and send the first timestamp to the vehicle server 12.

In one possible implementation, when there is any charging gun being inserted into a charging port of a vehicle, the charging gun may send a notification, indicating that it is inserted into the charging port, to the charging pile server 13. This information may include a second timestamp indicating that the charging gun is inserted into the charging port, and the charging pile server 13 may detect that the charging gun is inserted into the charging port. When the charging pile server 13 detects that there is any charging gun being inserted into a charging port, the charging pile server 13 may send the charging gun identifier of that charging gun and the second timestamp, indicating that the charging gun is inserted into the charging port, to the vehicle server 12. Since several charging guns may be inserted into the charging ports of different vehicles at the same time or in the same time period, the charging pile server 13 may send several charging gun identifiers to the vehicle server, where each charging gun identifier has its corresponding second timestamp. Accordingly, there may also be several second timestamps.

In a possible implementation, after the vehicle server 12 receives the first timestamp sent by the vehicle 11, and several charging gun identifiers and corresponding second timestamps sent by the charging pile server 13, for each charging gun identifier sent by the charging pile server 13, the vehicle server 12 may first determine whether the charging gun identifier is a candidate charging gun identifier based on the previously determined candidate charging gun identifiers corresponding to the target parking space identifier, thereby first identifying, from these several charging gun identifiers, charging gun identifiers that are candidate charging gun identifiers. Next, for each identified charging gun identifier, the vehicle server 12 determines whether the time difference between the second timestamp corresponding to the charging gun identifier and the first timestamp is less than a set time threshold. If among the identified charging gun identifiers, there is only one charging gun identifier (for the convenience of description, this charging gun identifier is called the target charging gun identifier) whose corresponding second timestamp has a time difference with the first timestamp that is less than the set time threshold (i.e., for all candidate charging gun identifiers corresponding to the target parking space identifier, there is only one that corresponds to a second timestamp whose time difference with the first timestamp is less than the time threshold), then the charging gun identifier whose time difference with the first timestamp is less than the set time threshold may be considered the target charging gun identifier. It is considered that the charging gun inserted into the charging port of the vehicle is the charging gun 14 corresponding to the target charging gun identifier. A charging command may be sent to the charging pile server 13, where the charging command may carry the target charging gun identifier. Further, among the identified charging gun identifiers, if there are at least two (or more) charging gun identifiers with the time difference between the corresponding second timestamps and the first timestamp is less than the set time threshold (i.e., for all candidate charging gun identifiers corresponding to the target parking space identifier, there are at least two that correspond to a second timestamp whose time difference with the first timestamp is less than the time threshold), then it may be considered that among the charging guns corresponding to each candidate charging gun identifier, there are currently at least two charging guns that are intended to be used by different vehicles respectively. How to charge the vehicle 11 in this case will be introduced in detail in subsequent embodiments and will not be specified here.

In addition, when determining the target charging gun identifier, the vehicle server 12 may also receive the first timestamp sent by the vehicle 11, and several charging gun identifiers and corresponding second timestamps sent by the charging pile server 13. Then, for each second timestamp sent by the charging pile server 13, the vehicle server 12 may determine whether the time difference between the second timestamp and the first timestamp is less than the set time threshold, thereby first identifying, from the several second timestamps, the second timestamps whose time difference with the first timestamp is less than the set time threshold. Next, for each identified second timestamp, the vehicle server 12 determines whether the charging gun identifier corresponding to the second timestamp is a candidate charging gun identifier. If among the charging gun identifiers corresponding to the identified second timestamps, there is only one charging gun identifier that is a candidate charging gun identifier, it may be then considered that for all candidate charging gun identifiers corresponding to the target parking space identifier, there is only one that corresponds to a second timestamp whose time difference with the first timestamp is less than the time threshold. Then the only charging gun identifier whose time difference between the corresponding second timestamp and the first timestamp is less than the set time threshold and whose charging gun identifier is included in the candidate charging gun identifiers may be considered the target charging gun identifier. It is considered that the charging gun inserted into the charging port of the vehicle 11 is the charging gun 14 corresponding to the target charging gun identifier. A charging command may be sent to the charging pile server 13, where the charging command may carry the target charging gun identifier. In addition, among all charging gun identifiers corresponding to the identified second timestamps, when there are at least two (or more) charging gun identifiers considered as candidate charging gun identifiers (i.e., for all candidate charging gun identifiers corresponding to the target parking space identifier, there are at least two that correspond to a second timestamp whose time difference with the first timestamp is less than the time threshold), then it may be considered that among the charging guns corresponding to all candidate charging gun identifier, there are currently at least two charging guns that are intended to be used by different vehicles. How to charge the vehicle 11 in this case will be introduced in detail in subsequent embodiments and will not be specified here.

In one possible implementation, after receiving the charging command sent by the vehicle server 12, the charging pile server 13 may identify the target charging gun identifier carried in the charging command and may send a charging instruction to the charging gun 14 corresponding to the target charging gun identifier. After receiving the charging instruction, the charging gun 14 corresponding to the target charging gun identifier may charge the vehicle connected to the charging gun, details of which will not be further described here.

In the embodiments of the present disclosure, if the vehicle detects an intention-to-charge event showing the charging port being unlocked, the vehicle sends the target parking space identifier of the parking space where the vehicle is located to the vehicle server. When the vehicle detects that the charging port is being inserted with a charging gun, the vehicle may send a first timestamp to the vehicle server. When the charging pile server detects that there is any charging gun being inserted into a charging port, the charging pile server may send the charging gun identifier of that charging gun and the corresponding second timestamp to the vehicle server. After the vehicle server receives the target parking space identifier, the vehicle server may determine the candidate charging gun identifiers corresponding to the target parking space identifier based on a pre-stored correspondence between parking space identifiers and charging gun identifiers. After receiving the first timestamp, the charging gun identifiers and the corresponding second timestamps, if it is determined that, among all candidate charging gun identifiers corresponding to the target parking space identifier, there is only one that corresponds to a second timestamp whose time difference with the first timestamp is less than the time threshold, then a charging command is sent to the charging pile server, and the charging command carries the target charging gun identifier corresponding to the second timestamp whose time difference is less than the time threshold. After receiving the charging command, the charging pile server may send a charging instruction to the charging gun corresponding to the target charging gun identifier. After receiving the charging instruction, the charging gun corresponding to the target charging gun identifier may charge the vehicle connected to itself. Since the present disclosure may determine that, among all candidate charging gun identifiers corresponding to the target parking space identifier, there is only one that corresponds to a second timestamp whose time difference with the first timestamp is less than the time threshold, the charging gun identifier corresponding to the unique second timestamp whose time difference is less than the time threshold is considered the target charging gun identifier, and a charging command carrying the target charging gun identifier is sent to the charging pile server. Based on this, the purpose of quickly and accurately charging the vehicle may be achieved.

In addition, since the present disclosure may quickly and accurately determine the target charging gun identifier of the charging gun connected to the vehicle, it may effectively avoid a situation where the charging gun originally connected to the vehicle is charging gun A, but a charging instruction is eventually sent to charging gun B, while charging gun B is not currently connected to any vehicle, resulting in charging failure. Or it may effectively avoid a situation where the charging gun originally connected to vehicle No. 1 is charging gun A, and the charging gun connected to vehicle No. 2 is charging gun B, but it is mistakenly believed that the charging gun connected to vehicle No. 1 is charging gun B, and the charging gun connected to vehicle No. 2 is charging gun A, resulting in incorrect charging fee billing and fund deduction.

### Embodiment 2

In order to accurately charge a vehicle, based on the above embodiments, in an embodiment of the present disclosure, the vehicle server is further configured to send a prompt message, for reinserting charging gun, to the vehicle if it is determined that, among all candidate charging gun identifiers corresponding to the target parking space identifier, there are at least two that correspond to a second timestamp whose time difference with the first timestamp is less than a time threshold.

The vehicle is further configured to receive and output the prompt message.

In one possible implementation, among all candidate charging gun identifiers corresponding to the target parking space identifier, when there are at least two that correspond to a second timestamp whose time difference with the first timestamp is less than a time threshold, it may be considered that at least two charging guns corresponding to the candidate charging gun identifiers are currently intended to be used by different vehicles. To avoid charging failure or incorrect fund deduction, the vehicle server 12 may send a prompt message, for reinserting charging gun, to the vehicle 11. After receiving the prompt message, the vehicle 11 may output the prompt message, and the owner may reinsert the charging gun into the charging port according to the prompt message. When the owner reinserts the charging gun into the charging port, the vehicle 11 may detect that the charging port is being inserted with a charging gun and may regenerate a first timestamp. The vehicle 11 then repeats the step of sending the generated first timestamp to the vehicle server 12 as described in the above embodiments. The charging pile server 13 will also detect that a charging gun is inserted into the charging port again. The charging pile server 13 may repeat the step of sending the charging gun identifier and the corresponding second timestamp of the charging gun to the vehicle server 12 as described in the above embodiments. Correspondingly, the vehicle server 12 will also repeat the steps of receiving the first timestamp sent by the vehicle 11 and receiving the charging gun identifiers and the corresponding second timestamps sent by the charging pile server 13 as described in the above embodiments, and determine whether among all candidate charging gun identifiers corresponding to the target parking space identifier, there is only one that corresponds to a second timestamp whose time difference with the first timestamp is less than the time threshold. If so, the vehicle server 12 sends a charging command to the charging pile server 13, where the charging command carries the target charging gun identifier corresponding to the second timestamp whose time difference is less than the time threshold. It is understood that if it is determined that no candidate charging gun identifier corresponding to the target parking space identifier uniquely corresponds to a second timestamp whose time difference with the first timestamp is less than the time threshold, the vehicle server 12 may again perform the step of sending a prompt message to the vehicle 11, until it is determined that among all candidate charging gun identifiers corresponding to the target parking space identifier of the parking space where the vehicle 11 is located, there is only one that corresponds to a second timestamp whose time difference with the first timestamp is less than the time threshold. The specific detail will not be repeated here.

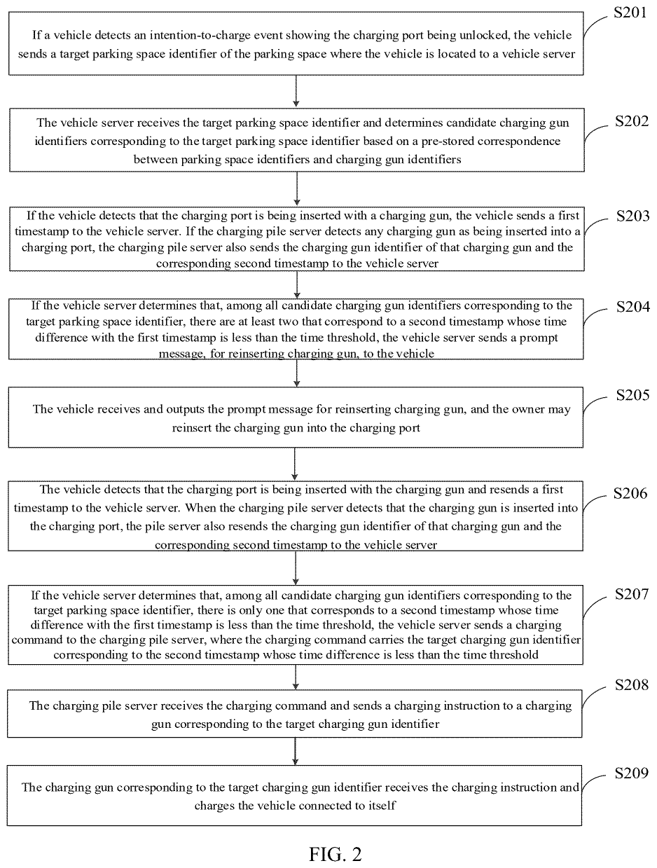

For ease of understanding, the vehicle charging process provided by the present disclosure is explained below through a specific embodiment. Referring to FIG. 2, which shows a schematic diagram of a first vehicle charging process in accordance with some embodiments.

The process includes the following steps.
S201: If a vehicle detects an intention-to-charge event showing the charging port being unlocked, the vehicle sends a target parking space identifier of the parking space where the vehicle is located to a vehicle server.
S202: The vehicle server receives the target parking space identifier and determines candidate charging gun identifiers corresponding to the target parking space identifier based on a pre-stored correspondence between parking space identifiers and charging gun identifiers.
S203: If the vehicle detects that the charging port is being inserted with a charging gun, the vehicle sends a first timestamp to the vehicle server. If the charging pile server detects any charging gun as being inserted into a charging port, the charging pile server also sends the charging gun identifier of that charging gun and the corresponding second timestamp to the vehicle server.
S204: If the vehicle server determines that, among all candidate charging gun identifiers corresponding to the target parking space identifier, there are at least two that correspond to a second timestamp whose time difference with the first timestamp is less than the time threshold, the vehicle server sends a prompt message, for reinserting charging gun, to the vehicle.
S205: The vehicle receives and outputs the prompt message for reinserting charging gun, and the owner may reinsert the charging gun into the charging port.
S206: The vehicle detects that the charging port is being inserted with the charging gun and resends a first timestamp to the vehicle server. When the charging pile server detects that the charging gun is inserted into the charging port, the pile server also resends the charging gun identifier of that charging gun and the corresponding second timestamp to the vehicle server.
S207: If the vehicle server determines that, among all candidate charging gun identifiers corresponding to the target parking space identifier, there is only one that corresponds to a second timestamp whose time difference with the first timestamp is less than the time threshold, the vehicle server sends a charging command to the charging pile server, where the charging command carries the target charging gun identifier corresponding to the second timestamp whose time difference is less than the time threshold.
S208: The charging pile server receives the charging command and sends a charging instruction to a charging gun corresponding to the target charging gun identifier.
S209: The charging gun corresponding to the target charging gun identifier receives the charging instruction and charges the vehicle connected to itself.

Furthermore, in addition to being able to send a prompt message to the vehicle, the present disclosure also provides another way to send a prompt message. Specifically, based on the above embodiments, in the embodiments of the present disclosure, the vehicle server is further configured to send a warning message to the charging pile server if it is determined that, among all candidate charging gun identifiers corresponding to the target parking space identifier, there are at least two that correspond to a second timestamp whose time difference with the first timestamp is less than a time threshold. The warning message carries the to-be-verified charging gun identifier corresponding to each of the at least two second timestamps whose time difference is less than the time threshold.

The charging pile server is further configured to receive the warning message, and send a prompt message, for reinserting charging gun, to the charging gun corresponding to the to-be-verified charging gun identifier.

The charging gun corresponding to the to-be-verified charging gun identifier is configured to receive and output the prompt message.

In a possible implementation, among all candidate charging gun identifiers corresponding to the target parking space identifier, when there are at least two that correspond to a second timestamp whose time difference with the first timestamp is less than a time threshold, it may be considered that, among all charging guns corresponding to the candidate charging gun identifiers, there are at least two charging guns that are currently to be used. In order to avoid charging failure or incorrect fund deduction, the vehicle server may send a warning message to the charging pile server. The warning message may carry the charging gun identifiers corresponding to the at least two second timestamps whose time difference is less than the time threshold (for the convenience of description, the charging gun identifiers corresponding to these at least two second timestamps are referred to as to-be-verified charging gun identifiers).

In one possible implementation, after receiving the warning message, the charging pile server may send a prompt message, for inserting the charging gun, to a charging gun corresponding to a to-be-verified charging gun identifier. After receiving the prompt message, the charging gun corresponding to the to-be-verified charging gun identifier may output the prompt message. The car owner may reinsert the charging gun into the charging port according to the prompt message. After the car owner reinserts the charging gun into the charging port, the vehicle may detect that the charging port is being inserted with the charging gun and may regenerate a first timestamp. The vehicle then repeats the step of sending the generated first timestamp to the vehicle server as described in the above embodiments. The charging pile server will also detect that a charging gun is inserted into the charging port again. The charging pile server may repeat the step of sending the charging gun identifier and the corresponding second timestamp of the charging gun to the vehicle server as described in the above embodiments.

Accordingly, the vehicle server will also repeat the steps of receiving the first timestamp sent by the vehicle, receiving the charging gun identifiers and the corresponding second timestamps sent by the charging pile server, and determining whether among all candidate charging gun identifiers corresponding to the target parking space identifier, there is only one that corresponds to a second timestamp whose time difference with the first timestamp is less than a time threshold as described in the above embodiments. These steps will not be repeated here.

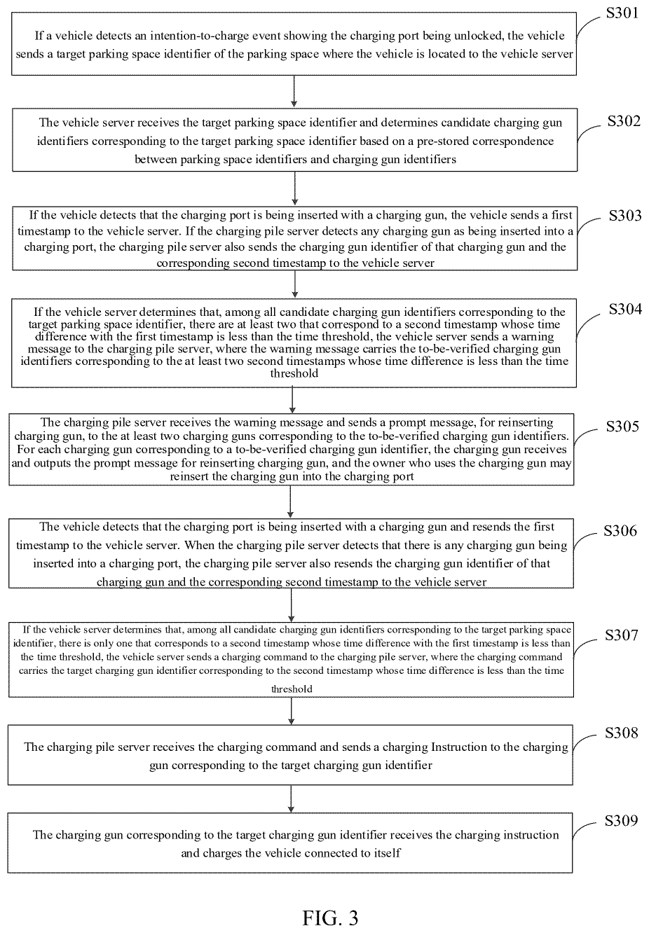

For ease of understanding, the vehicle charging process provided by the present disclosure is explained below through a specific embodiment. Referring to FIG. 3, which shows a schematic diagram of a second vehicle charging process in accordance with some embodiments. The process includes the following steps.
S301: If a vehicle detects an intention-to-charge event showing the charging port being unlocked, the vehicle sends a target parking space identifier of the parking space where the vehicle is located to the vehicle server.
S302: The vehicle server receives the target parking space identifier and determines candidate charging gun identifiers corresponding to the target parking space identifier based on a pre-stored correspondence between parking space identifiers and charging gun identifiers.
S303: If the vehicle detects that the charging port is being inserted with a charging gun, the vehicle sends a first timestamp to the vehicle server. If the charging pile server detects any charging gun as being inserted into a charging port, the charging pile server also sends the charging gun identifier of that charging gun and the corresponding second timestamp to the vehicle server.
S304: If the vehicle server determines that, among all candidate charging gun identifiers corresponding to the target parking space identifier, there are at least two that correspond to a second timestamp whose time difference with the first timestamp is less than the time threshold, the vehicle server sends a warning message to the charging pile server, where the warning message carries the to-be-verified charging gun identifiers corresponding to the at least two second timestamps whose time difference is less than the time threshold.
S305: The charging pile server receives the warning message and sends a prompt message, for reinserting charging gun, to the at least two charging guns corresponding to the to-be-verified charging gun identifiers. For each charging gun corresponding to a to-be-verified charging gun identifier, the charging gun receives and outputs the prompt message for reinserting charging gun, and the owner who uses the charging gun may reinsert the charging gun into the charging port.
S306: The vehicle detects that the charging port is being inserted with a charging gun and resends the first timestamp to the vehicle server. When the charging pile server detects that there is any charging gun being inserted into a charging port, the charging pile server also resends the charging gun identifier of that charging gun and the corresponding second timestamp to the vehicle server.
S307: If the vehicle server determines that, among all candidate charging gun identifiers corresponding to the target parking space identifier, there is only one that corresponds to a second timestamp whose time difference with the first timestamp is less than the time threshold, the vehicle server sends a charging command to the charging pile server, where the charging command carries the target charging gun identifier corresponding to the second timestamp whose time difference is less than the time threshold.
S308: The charging pile server receives the charging command and sends a charging instruction to the charging gun corresponding to the target charging gun identifier.
S309: The charging gun corresponding to the target charging gun identifier receives the charging instruction and charges the vehicle connected to itself.

Since the present disclosure may output a prompt message, for reinserting charging gun, through the vehicle or charging gun when it is determined that, among all candidate charging gun identifiers corresponding to the target parking space identifier, there are at least two that correspond to a second timestamp whose time difference with the first timestamp is less than a time threshold, the purpose of accurately charging the vehicle may be achieved based on this.

### Embodiment 3

In order to quickly and accurately determine the target charging gun identifier, based on the above embodiments, in the embodiments of the present disclosure, the vehicle server is further configured to send a waiting-for-charge notification to the charging pile server, where the waiting-for-charge notification carries each candidate charging gun identifier.

The charging pile server is further configured to receive the waiting-for-charge notification, and for all charging guns corresponding to the respective candidate charging gun identifiers, if any charging gun is detected as being inserted into a charging port, send the charging gun identifier of the charging gun and the corresponding second timestamp to the vehicle server.

In one possible implementation, to quickly and accurately determine the target charging gun identifier, after determining the candidate charging gun identifiers corresponding to the target parking space identifier, the vehicle server may send a waiting-for-charge notification to the charging pile server. This waiting-for-charge notification may include the candidate charging gun identifiers. Upon receiving the waiting-for-charge notification, the charging pile server may monitor which charging gun corresponding to each candidate charging gun identifier is about to be inserted into the charging port. Upon detecting any charging gun corresponding to a candidate charging gun identifier as being inserted into the charging port, the charging gun identifier of that charging gun and the corresponding second timestamp may be sent to the vehicle server. It is understood that the charging gun identifiers sent by the charging pile server at this time are all identifiers among the candidate charging gun identifiers. After receiving such charging gun identifiers and corresponding second timestamps, the vehicle server may determine whether there is only one charging gun identifier whose corresponding second timestamp has a time difference with the first timestamp that is less than a set time threshold. If there is only one such identifier, it may be assumed that, among all candidate charging gun identifiers corresponding to the target parking space identifier, there is only one that corresponds to a second timestamp whose time difference with the first timestamp is less than the time threshold. This charging gun identifier may be considered the target charging gun identifier, and a charging command carrying the target charging gun identifier may be sent to the charging pile server. Optionally, if the vehicle server determines that there are at least two charging gun identifiers whose corresponding time difference between the second timestamp and the first timestamp is less than the set time threshold, it may be considered that, among all candidate charging gun identifiers corresponding to the target parking space identifier, there are at least two that correspond to a second timestamp whose time difference with the first timestamp is less than the time threshold. The process of sending a prompt message to the vehicle or the process of sending a warning message to the charging pile server as described in the above embodiments may be performed, and no further details will be given here.

### Embodiment 4

In order to charge the vehicle quickly and accurately, based on the above embodiments, in the embodiments of the present disclosure, the vehicle server is further configured to send a monitoring command to the vehicle to check whether the charging port is being inserted with a charging gun.

The vehicle is further configured to receive the monitoring command and, if the charging port is detected as being inserted with a charging gun, send a first timestamp to the vehicle server.

In one possible implementation, when the vehicle detects an intention-to-charge event showing the charging port being unlocked, the vehicle sends the target parking space identifier of the parking space where the vehicle is located to the vehicle server. After receiving the target parking space identifier sent by the vehicle, the vehicle server may send a monitoring command to the vehicle to check whether the charging port is being inserted with a charging gun. After the vehicle receives the monitoring command, if the vehicle detects that the charging port is being inserted with a charging gun, the vehicle may generate a corresponding first timestamp and send the first timestamp to the vehicle server. After receiving the first timestamp, the vehicle server may determine the target charging pile identifier based on the first timestamp, the charging pile identifier sent by the charging pile server, and the corresponding second timestamp. The process of determining the target charging pile identifier is the same as in the above embodiments and will not be repeated here.

For ease of understanding, the vehicle charging process provided by the present disclosure is explained below through a specific embodiment. Referring to FIG. 4, which shows a schematic diagram of a third vehicle charging process in accordance with some embodiments. The process includes the following steps.
S401: If a vehicle detects an intention-to-charge event showing the charging port being unlocked, the vehicle sends a target parking space identifier of the parking space where the vehicle is located to the vehicle server.
S402: The vehicle server receives the target parking space identifier and, based on a pre-stored correspondence between parking space identifiers and charging gun identifiers, determines candidate charging gun identifiers corresponding to the target parking space identifier. The vehicle server sends a waiting-for-charge notification to the charging pile server, including the candidate charging gun identifiers. The vehicle server may also simultaneously send a monitoring command to the vehicle to check whether the charging port is being inserted with a charging gun.
S403: If the vehicle detects that the charging port is being inserted with a charging gun, the vehicle sends a first timestamp to the vehicle server. For all charging guns corresponding to the candidate charging gun identifiers, if any charging gun is detected as being inserted into a charging port, the charging pile server sends the charging gun identifier of that charging gun and the corresponding second timestamp to the vehicle server.
S404: If the vehicle server determines that, among all candidate charging gun identifiers corresponding to the target parking space identifier, there is only one that corresponds to a second timestamp whose time difference with the first timestamp is less than the time threshold, the vehicle server sends a charging command to the charging pile server, and the charging command carries the target charging gun identifier corresponding to the second timestamp whose time difference is less than the time threshold.
S405: The charging pile server receives the charging command and sends a charging instruction to the charging gun corresponding to the target charging gun identifier.
S406: The charging gun corresponding to the target charging gun identifier receives the charging instruction and charges the vehicle connected to itself.

### Embodiment 5

In order to charge the vehicle quickly and accurately, based on the above embodiments, in the embodiments of the present disclosure, the vehicle is specifically configured to send the target parking space identifier and location information of the parking space where the vehicle is located to the vehicle server.

The vehicle server is further configured to receive the location information and determine the target parking lot corresponding to the location information. If the target parking lot is in the currently stored parking lot whitelist, then the candidate charging gun identifiers corresponding to the target parking space identifier are determined based on the pre-stored correspondence between parking space identifiers and charging gun identifiers.

In one possible implementation, considering that some parking lots may not support the contactless charging method in the embodiments of the present disclosure, in order to charge the vehicle quickly and accurately, when a vehicle detects an intention-to-charge event showing the charging port being unlocked, the vehicle may also obtain the location information of the parking space where the vehicle is located, that is, the current location information of the vehicle (such as latitude and longitude information). Here, the location information of the vehicle may be obtained based on a navigation module in the vehicle and the like, which will not be specified here. The vehicle may send the location information and the target parking space identifier of the parking space where the vehicle is located to the vehicle server, so that the vehicle server may know that the vehicle wants to charge based on this information. Optionally, when the vehicle sends the target parking space identifier and location information to the vehicle server, the vehicle may also send the timestamp, of detecting that the charging port is unlocked, to the vehicle server, so that the vehicle server may know that the vehicle wants to charge based on this information.

In one possible implementation, after receiving the location information, the vehicle server may determine a target parking lot (also referred to as a parking lot) corresponding to the location information. The target parking lot corresponding to the vehicle's location information may be determined based on a pre-stored correspondence between the location information and parking lots. Alternatively, the pre-stored location information of each parking lot may be compared to the vehicle's location information to determine the target parking lot corresponding to (matching) the vehicle's location information. The present disclosure does not specifically limit the specific method for determining the target parking lot. Optionally, after determining the target parking lot, the vehicle server may determine whether the target parking lot is on a currently stored parking lot whitelist. If the target parking lot is on the currently stored parking lot whitelist, the vehicle may be deemed eligible for charging using the charging guns in the target parking lot. Subsequent steps may be performed to determine candidate charging gun identifiers corresponding to the target parking lot identifier based on a pre-stored correspondence between parking space identifiers and charging gun identifiers, detail of which will not be further described here. Conversely, if the target parking lot is not on the currently stored parking lot whitelist, the vehicle may be deemed ineligible for charging using the charging guns in the target parking lot. A message indicating that the contactless charging is not supported may be sent to the vehicle, which the vehicle may receive and output.

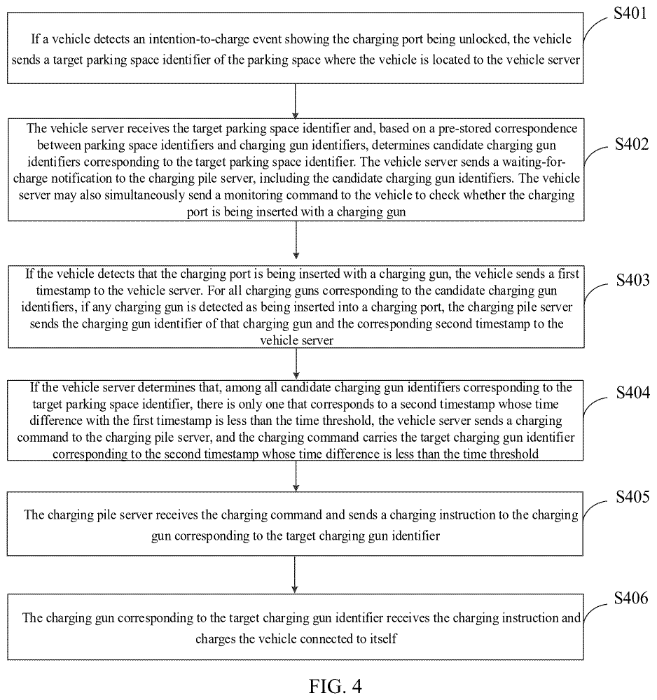

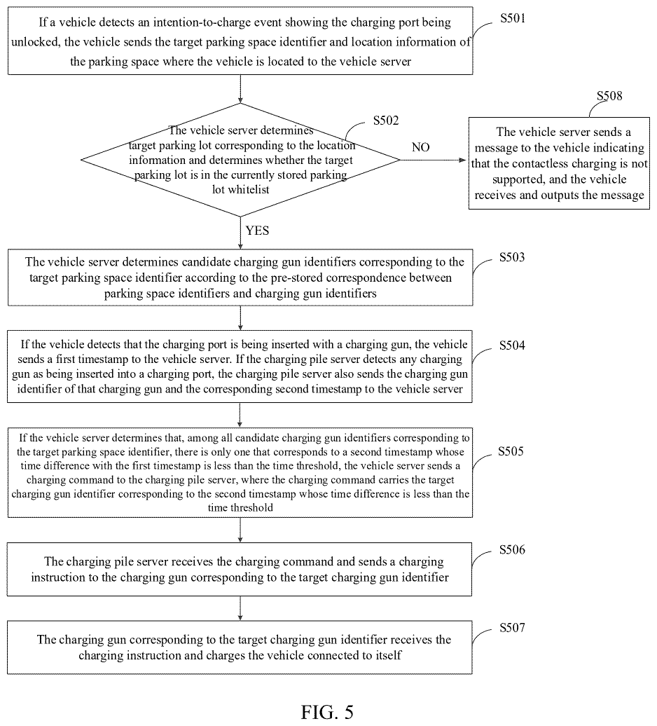

For ease of understanding, the vehicle charging process provided by the present disclosure is described below through an embodiment. Referring to FIG. 5, which shows a schematic diagram of a fourth vehicle charging process in accordance with some embodiments. The process includes the following steps.
S501: If a vehicle detects an intention-to-charge event showing the charging port being unlocked, the vehicle sends the target parking space identifier and location information of the parking space where the vehicle is located to the vehicle server.
S502: The vehicle server determines the target parking lot corresponding to the location information and determines whether the target parking lot is in the currently stored parking lot whitelist. If so, proceed to S503; if not, proceed to S508.
S503: The vehicle server determines candidate charging gun identifiers corresponding to the target parking space identifier according to the pre-stored correspondence between parking space identifiers and charging gun identifiers.
S504: If the vehicle detects that the charging port is being inserted with a charging gun, the vehicle sends a first timestamp to the vehicle server. If the charging pile server detects any charging gun as being inserted into a charging port, the charging pile server also sends the charging gun identifier of that charging gun and the corresponding second timestamp to the vehicle server.
S505: If the vehicle server determines that, among all candidate charging gun identifiers corresponding to the target parking space identifier, there is only one that corresponds to a second timestamp whose time difference with the first timestamp is less than the time threshold, the vehicle server sends a charging command to the charging pile server, where the charging command carries the target charging gun identifier corresponding to the second timestamp whose time difference is less than the time threshold.
S506: The charging pile server receives the charging command and sends a charging instruction to the charging gun corresponding to the target charging gun identifier.
S507: The charging gun corresponding to the target charging gun identifier receives the charging instruction and charges the vehicle connected to itself.
S508: The vehicle server sends a message to the vehicle indicating that the contactless charging is not supported, and the vehicle receives and outputs the message.

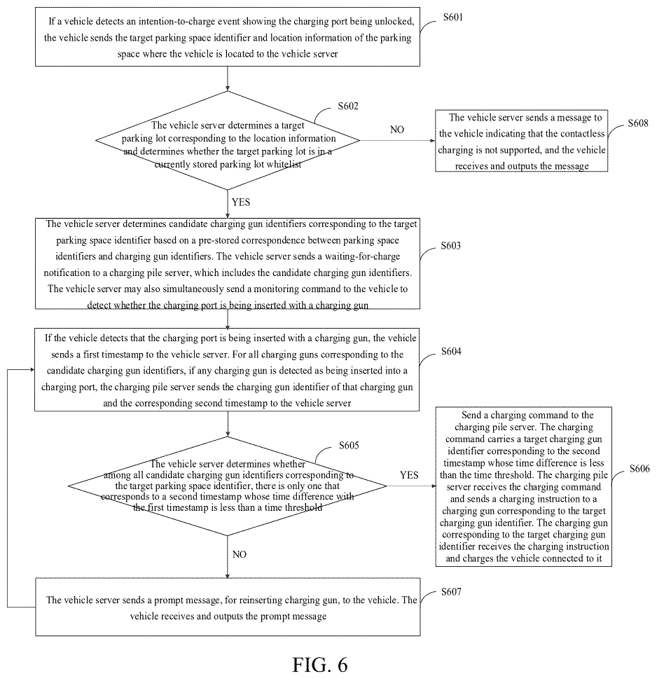

For ease of understanding, the vehicle charging process provided by the present disclosure is described below through an embodiment. Referring to FIG. 6, which shows a schematic diagram of a fifth vehicle charging process in accordance with some embodiments. The process includes the following steps.
S601: If a vehicle detects an intention-to-charge event showing the charging port being unlocked, the vehicle sends a target parking space identifier and location information of a parking space where the vehicle is located to a vehicle server.
S602: The vehicle server determines a target parking lot corresponding to the location information and determines whether the target parking lot is in a currently stored parking lot whitelist. If so, proceed to S603; if not, proceed to S608.
S603: The vehicle server determines candidate charging gun identifiers corresponding to the target parking space identifier based on a pre-stored correspondence between parking space identifiers and charging gun identifiers. The vehicle server sends a waiting-for-charge notification to a charging pile server, which includes the candidate charging gun identifiers. The vehicle server may also simultaneously send a monitoring command to the vehicle to detect whether the charging port is being inserted with a charging gun.
S604: If the vehicle detects that the charging port is being inserted with a charging gun, the vehicle sends a first timestamp to the vehicle server. For all charging guns corresponding to the candidate charging gun identifiers, if any charging gun is detected as being inserted into a charging port, the charging pile server sends the charging gun identifier of that charging gun and the corresponding second timestamp to the vehicle server.
S605: The vehicle server determines whether among all candidate charging gun identifiers corresponding to the target parking space identifier, there is only one that corresponds to a second timestamp whose time difference with the first timestamp is less than a time threshold. If so, proceed to S606; if not, proceed to S607.
S606: Send a charging command to the charging pile server. The charging command carries a target charging gun identifier corresponding to the second timestamp whose time difference is less than the time threshold. The charging pile server receives the charging command and sends a charging instruction to a charging gun corresponding to the target charging gun identifier. The charging gun corresponding to the target charging gun identifier receives the charging instruction and charges the vehicle connected to itself.
S607: The vehicle server sends a prompt message, for reinserting charging gun, to the vehicle. The vehicle receives and outputs the prompt message and proceeds to S604.

In addition, step S607 may also be: the vehicle server sends a warning message to the charging pile server, where the warning message carries at least two second timestamps with a time difference less than the time threshold, each corresponding to a to-be-verified charging gun identifier; the charging pile server receives the warning message, and sends a prompt message, for inserting the charging gun, to the charging gun corresponding to each to-be-verified charging gun identifier; the charging gun corresponding to the to-be-verified charging gun identifier receives and outputs the prompt message, and performs step S604.
S608: The vehicle server sends a message to the vehicle indicating that the contactless charging is not supported, and the vehicle receives and outputs the message.

In one possible implementation, in order to ensure that the first timestamps and the second timestamps are determined based on the same time reference and to improve the accuracy of charging the vehicle, when the vehicle is parked in a parking space, or when the vehicle detects an intention-to-charge event showing the charging port being unlocked, the vehicle may establish a connection with a charging pile near its parking space by means of near-field communication and the like, and perform clock synchronization, which will not be elaborated here.

### Embodiment 6

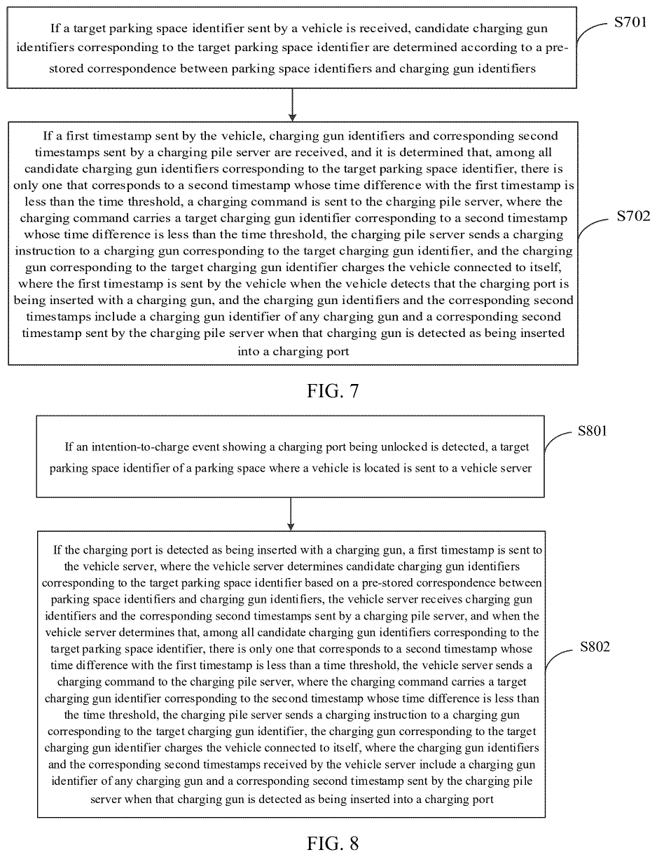

Based on the similar technical concept, the present disclosure provides a vehicle charging method, which is applied to a vehicle server. Referring to FIG. 7, which shows a schematic diagram of a sixth vehicle charging process in accordance with some embodiments.

The process includes the following steps.
S701: If a target parking space identifier sent by a vehicle is received, candidate charging gun identifiers corresponding to the target parking space identifier are determined according to a pre-stored correspondence between parking space identifiers and charging gun identifiers.
S702: If a first timestamp sent by the vehicle, charging gun identifiers and corresponding second timestamps sent by a charging pile server are received, and it is determined that, among all candidate charging gun identifiers corresponding to the target parking space identifier, there is only one that corresponds to a second timestamp whose time difference with the first timestamp is less than the time threshold, a charging command is sent to the charging pile server, where the charging command carries a target charging gun identifier corresponding to a second timestamp whose time difference is less than the time threshold, the charging pile server sends a charging instruction to a charging gun corresponding to the target charging gun identifier, and the charging gun corresponding to the target charging gun identifier charges the vehicle connected to itself, where the first timestamp is sent by the vehicle when the vehicle detects that the charging port is being inserted with a charging gun, and the charging gun identifiers and the corresponding second timestamps include a charging gun identifier of any charging gun and a corresponding second timestamp sent by the charging pile server when that charging gun is detected as being inserted into a charging port.

In one possible implementation, the method further includes: if it is determined that, among all candidate charging gun identifiers corresponding to the target parking space identifier, there are at least two that correspond to a second timestamp whose time difference with the first timestamp is less than a time threshold, sending a prompt message, for reinserting charging gun, to the vehicle, so that the vehicle receives and outputs the prompt message.

In one possible implementation, the method further includes: if it is determined that, among all candidate charging gun identifiers corresponding to the target parking space identifier, there are at least two that correspond to a second timestamp whose time difference with the first timestamp is less than the time threshold, sending a warning message to the charging pile server, where the warning message carries to-be-verified charging gun identifiers corresponding to the at least two second timestamps whose time difference is less than the time threshold, so that the charging pile server sends a prompt message, for reinserting charging gun, to a charging gun corresponding to a to-be-verified charging gun identifier, so that the charging gun corresponding to the to-be-verified charging gun identifier receives and outputs the prompt message.

In a possible implementation, before determining the candidate charging gun identifiers corresponding to the target parking space identifier based on the pre-stored correspondence between parking space identifiers and charging gun identifiers, the method further includes: receiving the location information sent by the vehicle and determine the target parking lot corresponding to the location information, and if the target parking lot is in the currently stored parking lot whitelist, performing the subsequent step of determining the candidate charging gun identifiers corresponding to the target parking space identifier based on the pre-stored correspondence between parking space identifiers and charging gun identifiers.

In a possible implementation, after determining each candidate charging gun identifier corresponding to the target parking space identifier and before receiving the charging gun identifiers and the corresponding second timestamps sent by the charging pile server, the method further includes: sending a waiting-for-charge notification to the charging pile server, where the waiting-for-charge notification carries all candidate charging gun identifiers, so that, for all charging guns corresponding to the respective candidate charging gun identifiers, if any charging gun is detected as being inserted into a charging port, the charging pile server sends the charging gun identifier of that charging gun and the corresponding second timestamp to the vehicle server.

In a possible implementation, after receiving the target parking space identifier sent by the vehicle and before receiving the first timestamp sent by the vehicle, the method further includes: sending a monitoring command to the vehicle to detect whether the charging port is being inserted with a charging gun, where if the vehicle detects that the charging port is being inserted with a charging gun, the vehicle sends the first timestamp to the vehicle server.

Based on the similar technical concept, the present disclosure provides a vehicle charging method, which is applied to a vehicle. Referring to FIG. 8, which shows a schematic diagram of a seventh vehicle charging process in accordance with some embodiments. The process includes the following steps.
S801: If an intention-to-charge event showing a charging port being unlocked is detected, a target parking space identifier of a parking space where a vehicle is located is sent to a vehicle server.
S802: If the charging port is detected as being inserted with a charging gun, a first timestamp is sent to the vehicle server, where the vehicle server determines candidate charging gun identifiers corresponding to the target parking space identifier based on a pre-stored correspondence between parking space identifiers and charging gun identifiers, the vehicle server receives charging gun identifiers and the corresponding second timestamps sent by a charging pile server, and when the vehicle server determines that, among all candidate charging gun identifiers corresponding to the target parking space identifier, there is only one that corresponds to a second timestamp whose time difference with the first timestamp is less than a time threshold, the vehicle server sends a charging command to the charging pile server, where the charging command carries a target charging gun identifier corresponding to the second timestamp whose time difference is less than the time threshold, the charging pile server sends a charging instruction to a charging gun corresponding to the target charging gun identifier, the charging gun corresponding to the target charging gun identifier charges the vehicle connected to itself, where the charging gun identifiers and the corresponding second timestamps received by the vehicle server include a charging gun identifier of any charging gun and a corresponding second timestamp sent by the charging pile server when that charging gun is detected as being inserted into a charging port.

In one possible implementation, the method further includes: receiving and outputting a prompt message, for reinserting charging gun, sent by the vehicle server.

In a possible implementation, sending the target parking space identifier of the parking space where the vehicle is located to the vehicle server includes: sending the target parking space identifier along with the corresponding location information of the parking space where the vehicle is located to the vehicle server.

In one possible implementation, after detecting an intention-to-charge event showing the charging port being unlocked, before the charging port is detected as being inserted with a charging gun and sending the first timestamp to the vehicle server, the method further includes: receiving a monitoring command sent by the vehicle server to check whether the charging port is being inserted with a charging gun.

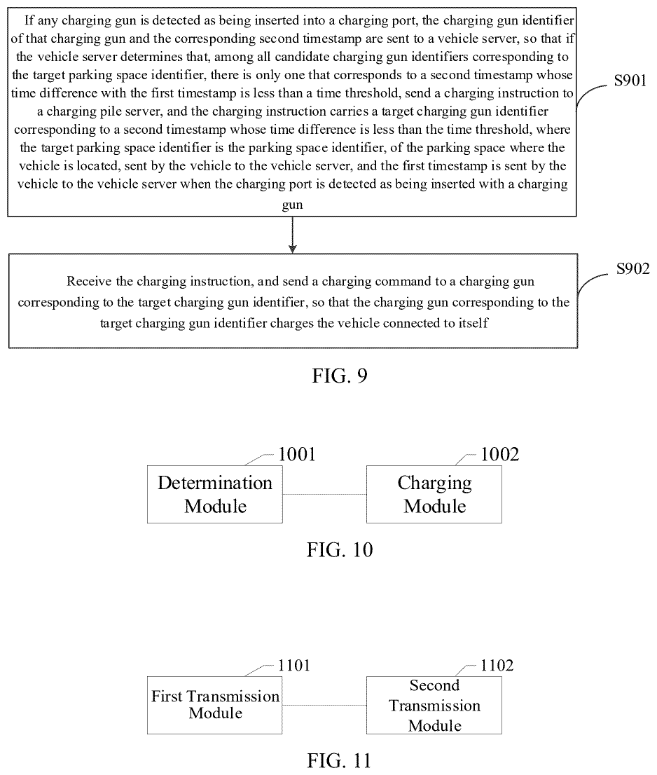

Based on the similar technical concept, the present disclosure provides a vehicle charging method, which is applied to a charging pile server. Referring to FIG. 9, which shows a schematic diagram of an eighth vehicle charging process in accordance with some embodiments. The process includes the following steps.
S901: If any charging gun is detected as being inserted into a charging port, the charging gun identifier of that charging gun and the corresponding second timestamp are sent to a vehicle server, so that if the vehicle server determines that, among all candidate charging gun identifiers corresponding to the target parking space identifier, there is only one that corresponds to a second timestamp whose time difference with the first timestamp is less than a time threshold, send a charging command to a charging pile server, and the charging command carries a target charging gun identifier corresponding to a second timestamp whose time difference is less than the time threshold, where the target parking space identifier is the parking space identifier, of the parking space where the vehicle is located, sent by the vehicle to the vehicle server, and the first timestamp is sent by the vehicle to the vehicle server when the charging port is detected as being inserted with a charging gun.
S902: Receive the charging command, and send a charging instruction to a charging gun corresponding to the target charging gun identifier, so that the charging gun corresponding to the target charging gun identifier charges the vehicle connected to itself.

In one possible implementation, the method further includes: receiving a warning message sent by the vehicle server, where the warning message is sent by the vehicle server when it is determined that, among all candidate charging gun identifiers corresponding to the target parking space identifier, there are at least two that correspond to a second timestamp whose time difference with the first timestamp is less than a time threshold, and the warning message carries to-be-verified charging gun identifiers corresponding the at least two second timestamps whose time difference is less than the time threshold, and sending a prompt message, for reinserting charging gun, to a charging gun corresponding to a to-be-verified charging gun identifier, so that the charging gun corresponding to the to-be-verified charging gun identifier receives and outputs the prompt message.

In a possible implementation, when any charging gun is detected as being inserted into the charging port, before sending the charging gun identifier of the charging gun and the corresponding second timestamp to the vehicle server, the method further includes: receiving a waiting-for-charge notification sent by the vehicle server, where the waiting-for-charge notification carries the identifier of each candidate charging gun, and perform subsequent steps for all the charging guns corresponding to the respective candidate charging gun identifiers.

### Embodiment 7

Based on the similar technical concept, the present disclosure provides a vehicle charging apparatus, which is applied to a vehicle server. Referring to FIG. 10, which shows a schematic diagram of a first vehicle charging apparatus in accordance with some embodiments, and the apparatus includes:

A determination module 1001, configured to, upon receiving a target parking space identifier sent by a vehicle, determine candidate charging gun identifiers corresponding to the target parking space identifier based on a pre-stored correspondence between parking space identifiers and charging gun identifiers.

A charging module 1002, configured to send a charging command to the charging pile server if it receives the first timestamp sent by the vehicle, the charging gun identifiers and the corresponding second timestamps sent by the charging pile server, and determines that, among all candidate charging gun identifiers corresponding to the target parking space identifier, there is only one that corresponds to a second timestamp whose time difference with the first timestamp is less than the time threshold, where the charging command carries the target charging gun identifier corresponding to a second timestamp whose time difference is less than the time threshold, enable the charging pile server to send a charging instruction to the charging gun corresponding to the target charging gun identifier, and enable the charging gun corresponding to the target charging gun identifier to charge the vehicle connected to itself, where the first timestamp is sent by the vehicle when the vehicle detects that the charging port is being inserted with a charging gun, and the charging gun identifiers and the corresponding second timestamps include a charging gun identifier of any charging gun and a corresponding second timestamp sent by the charging pile server when that charging gun is detected as being inserted into a charging port.

In one possible implementation, the charging module 1002 is also configured to send a prompt message, for reinserting charging gun, to the vehicle if it is determined that, among all candidate charging gun identifiers corresponding to the target parking space identifier, there are at least two that correspond to a second timestamp whose time difference with the first timestamp is less than a time threshold, so that the vehicle receives and outputs the prompt message.

In a possible implementation, the charging module 1002 is also configured to send a warning message to the charging pile server if it is determined that, among all candidate charging gun identifiers corresponding to the target parking space identifier, there are at least two that correspond to a second timestamp whose time difference with the first timestamp is less than a time threshold. The warning message carries a to-be-verified charging gun identifier corresponding to each of the at least two second timestamps whose time difference is less than the time threshold, so that the charging pile server sends a prompt message, for reinserting charging gun, to the charging gun corresponding to a to-be-verified charging gun identifier, so that the charging gun corresponding to the to-be-verified charging gun identifier receives and outputs the prompt message.

In a possible implementation, the determination module 1001 is further configured to receive the location information sent by the vehicle and determine the target parking lot corresponding to the location information, if the target parking lot is located in the currently stored parking lot whitelist, the subsequent step of determining the candidate charging gun identifiers corresponding to the target parking space identifier based on the pre-stored correspondence between parking space identifiers and charging gun identifiers is performed.

In a possible implementation, the charging module 1002 is also configured to send a waiting-for-charge notification to the charging pile server, where the waiting-for-charge notification carries each candidate charging gun identifier, so that, for all charging guns corresponding to the respective candidate charging gun identifiers, if any charging gun is detected as being inserted into a charging port, the charging pile server may send the charging gun identifier of the charging gun and the corresponding second timestamp to the vehicle server.

In a possible implementation, the charging module 1002 is further configured to send a monitoring command to the vehicle for detecting whether the charging port is being inserted with a charging gun, so that if the vehicle detects that the charging port is being inserted with a charging gun, the vehicle sends a first timestamp to the vehicle server.

Based on the similar technical concept, the present disclosure provides a vehicle charging apparatus, which is applied to a vehicle. Referring to FIG. 11, which shows a schematic diagram of a second vehicle charging apparatus in accordance with some embodiments, and the apparatus incudes:

A first transmission module 1101, configured to detect an intention-to-charge event showing the charging port being unlocked, and send a target parking space identifier of the parking space where the vehicle is located to the vehicle server.

A second transmission module 1102, configured to send a first timestamp to the vehicle server if the charging port is detected as being inserted with a charging gun, enable the vehicle server to determine the candidate charging gun identifiers corresponding to the target parking space identifier based on the pre-stored correspondence between parking space identifiers and charging gun identifiers, enable the vehicle server to receive the charging gun identifiers and the corresponding second timestamps sent by the charging pile server, and enable the vehicle server to send a charging command to the charging pile server when it is determined that, among all candidate charging gun identifiers corresponding to the target parking space identifier, there is only one that corresponds to a second timestamp whose time difference with the first timestamp is less than a time threshold, where the charging command carries the target charging gun identifier corresponding to the second timestamp whose time difference is less than the time threshold, enable the charging pile server to send a charging instruction to the charging gun corresponding to the target charging gun identifier, and enable the charging gun corresponding to the target charging gun identifier to charge the vehicle connected to itself, where the charging gun identifiers and the corresponding second timestamps received by the vehicle server include a charging gun identifier of any charging gun and a corresponding second timestamp sent by the charging pile server when that charging gun is detected as being inserted into a charging port.

In a possible implementation, the apparatus further includes:

A receiving module, configured to receive and output the prompt message, for reinserting charging gun, sent by the vehicle server.

In a possible implementation, the first transmission module 1101 is specifically configured to send the target parking space identifier and location information of the parking space where the vehicle is located to the vehicle server.

In a possible implementation, the receiving module is further configured to receive a monitoring command sent by the vehicle server to detect whether the charging port is being inserted with a charging gun.

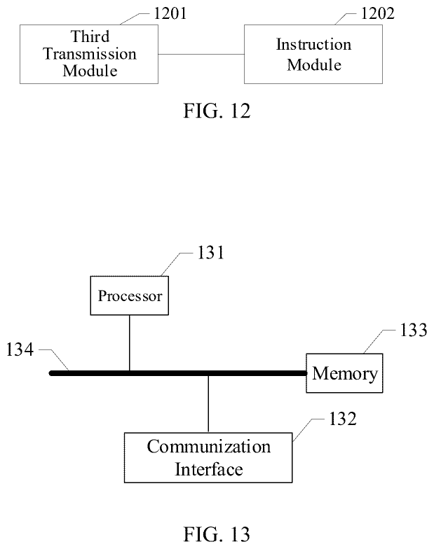

Based on the similar technical concept, the present disclosure provides a vehicle charging apparatus, which is applied to a charging pile server. Referring to FIG. 12, which shows a schematic diagram of a third vehicle charging apparatus in accordance with some embodiments, and the apparatus includes:

A third transmission module 1201, configured to send the charging gun identifier of any charging gun and the corresponding second timestamp to the vehicle server if that charging gun is detected as being inserted into the charging port, so that if the vehicle server determines that, among all candidate charging gun identifiers corresponding to the target parking space identifier, there is only one that corresponds to a second timestamp whose time difference with the first timestamp is less than a time threshold, a charging command is sent to the charging pile server, where the charging command carries the target charging gun identifier corresponding to the second timestamp whose time difference is less than the time threshold, where the target parking space identifier is the parking space identifier, of the parking space where the vehicle is located, sent by the vehicle to the vehicle server, and the first timestamp is sent by the vehicle to the vehicle server when the charging port is detected as being inserted with a charging gun.

An instruction module 1202, configured to receive the charging command and send a charging instruction to the charging gun corresponding to the target charging gun identifier, so that the charging gun corresponding to the target charging gun identifier charges the vehicle connected to itself.

In a possible implementation, the apparatus further includes:

A prompt module, configured to receive a warning message sent by the vehicle server, where the warning message is sent by the vehicle server when it is determined that, among all candidate charging gun identifiers corresponding to the target parking space identifier, there are at least two that correspond to a second timestamp whose time difference with the first timestamp is less than a time threshold, where the warning message carries the to-be-verified charging gun identifier corresponding to each of the at least two second timestamps whose time difference is less than the time threshold, and send a prompt message, for reinserting charging gun, to the charging gun corresponding to a to-be-verified charging gun identifier, so that the charging gun corresponding to the to-be-verified charging gun identifier receives and outputs the prompt message.

In a possible implementation, the third transmission module 1201 is also configured to receive a waiting-for-charge notification sent by the vehicle server, where the waiting-for-charge notification carries each candidate charging gun identifier, and for all charging guns corresponding to the respective candidate charging gun identifiers, if any charging gun is detected as being inserted into a charging port, the step of sending the charging gun identifier of the charging gun and the corresponding second timestamp to the vehicle server is performed.

### Embodiment 8

Based on the similar technical concept, the present disclosure also provides an electronic device. FIG. 13 shows a schematic structural diagram of an electronic device in accordance with some embodiments. As shown in FIG. 13, the electronic device includes: a processor 131, a communication interface 132, a memory 133, and a bus 134. The processor 131, the communication interface 132, and the memory 133 communicate with each other via the bus 134.

The memory 133 stores a computer program. When the program is executed by the processor 131, the processor 131 performs the steps of any of the above methods, which will not be repeated here.

The bus in the electronic device mentioned above may be a peripheral component interconnect (PCI) bus or an extended industry standard architecture (EISA) bus. This bus may be divided into address buses, data buses, control buses, etc. For ease of illustration, the figure shows only one thick line, but this does not mean that there is only one bus or only one type of bus.

The communication interface 132 is configured for communication between the electronic device and other devices.

The memory may include random access memory (RAM) or non-volatile memory (NVM), such as at least one disk storage. Alternatively, the memory may be at least one storage apparatus located away from the processor.

The processor may be a general-purpose processor, including a central processing unit, a network processor (NP), etc. The processor may also be a digital signal processing processor (DSP), an application-specific integrated circuit, a field programmable gate array or another programmable logic device, a discrete gate or transistor logic device, a discrete hardware component, etc.

Based on the similar technical concept, an embodiment of the present disclosure provides a computer-readable storage medium, which stores a computer program that may be executed by an electronic device. When the program runs on the electronic device, the electronic device implements the steps of any of the above methods when executing the program, which will not be repeated here.

The computer-readable storage medium may be any available medium or data storage device that may be accessed by the processor in the electronic device, including but not limited to magnetic storage such as floppy disks, hard disks, magnetic tapes, magneto-optical disks (MO), etc., optical storage such as CDs, DVDs, BDs, HVDs, etc., and semiconductor storage such as ROMs, EPROMs, EEPROMs, non-volatile memories (e.g., NAND flash), solid-state drives (SSDs), etc.

Based on the similar technical concept, the present disclosure provides a computer program product, which includes: computer program code, which, when executed on a computer, enables the computer to implement the method described in any of the above method embodiments applied to an electronic device.

The above embodiments may be implemented in whole or in part through software, hardware, firmware, or any combination thereof, and may be implemented in whole or in part in the form of a computer program product. The computer program product includes one or more computer instructions that, when loaded and executed on a computer, fully or partially generate the processes or functions described in the embodiments of the present disclosure.

Those skilled in the art will appreciate that the embodiments of the present disclosure may be provided as methods, systems, or computer program products. Therefore, the present disclosure may take the form of an entirely hardware embodiment, an entirely software embodiment, or an embodiment combining software and hardware. Furthermore, the present disclosure may take the form of a computer program product implemented on one or more computer-usable storage media (including but not limited to magnetic disk storage, CD-ROM, optical storage, etc.) containing computer-usable program code.

The present disclosure is described with reference to the flowcharts and/or block diagrams of the methods, devices (systems), and computer program products according to the present disclosure. It should be understood that each process and/or block in the flowcharts and/or block diagrams, as well as combinations of processes and/or blocks in the flowcharts and/or block diagrams, may be implemented by computer program instructions. These computer program instructions may be provided to a processor of a general-purpose computer, a special-purpose computer, an embedded processor, or another programmable data processing device to produce a machine, so that the instructions executed by the processor of the computer or another programmable data processing device produce a device for implementing the functions specified in one or more processes in the flowcharts and/or one or more blocks in the block diagrams.

These computer program instructions may also be stored in a computer-readable memory that may direct a computer or another programmable data processing apparatus to operate in a specific manner, so that the instructions stored in the computer-readable memory produce a product including an instruction apparatus that implements the functions specified in one or more processes in the flowchart and/or one or more boxes in the block diagram.

These computer program instructions may also be loaded onto a computer or another programmable data processing device so that a series of operating steps are executed on the computer or the other programmable device to produce a computer-implemented process, so that the instructions executed on the computer or the other programmable device provide steps for implementing the functions specified in one or more processes in the flowcharts and/or one or more boxes in the block diagrams.

Apparently, those skilled in the art may make various changes and modifications to the present disclosure without departing from the spirit and scope of the present disclosure. Thus, if these modifications and variations of the present disclosure fall within the scope of the claims of the present disclosure and their equivalents, the present disclosure is intended to include these modifications and variations.

1. A vehicle charging system, comprising:
a vehicle, configured to send a target parking space identifier of a parking space where the vehicle is located to a vehicle server when an intention-to-charge event showing a charging port being unlocked is detected, and send a first timestamp to the vehicle server if the charging port is detected as being inserted with a charging gun;
a charging pile server, configured to, if any charging gun is detected as being inserted into one charging port, send a charging gun identifier of that charging gun and a corresponding second timestamp to the vehicle server;
the vehicle server, configured to receive the target parking space identifier, determine candidate charging gun identifiers corresponding to the target parking space identifier based on a pre-stored correspondence between parking space identifiers and charging gun identifiers, receive charging gun identifiers and corresponding second timestamps, and if it is determined that, among all candidate charging gun identifiers corresponding to the target parking space identifier, there is only one that corresponds to a second timestamp whose time difference with the first timestamp is less than a time threshold, send a charging command to the charging pile server, wherein the charging command carries a target charging gun identifier corresponding to a second timestamp whose time difference is less than the time threshold,
wherein the charging pile server is further configured to receive the charging command and send a charging instruction to a charging gun corresponding to the target charging gun identifier; and
the charging gun corresponding to the target charging gun identifier, configured to receive the charging instruction and charge a connected vehicle.

2. The system according to claim 1, wherein:
the vehicle server is further configured to send a prompt message, for reinserting charging gun, to the vehicle if it is determined that, among all the candidate charging gun identifiers corresponding to the target parking space identifier, there are at least two that correspond to a second timestamp whose time difference with the first timestamp is less than the time threshold; and
the vehicle is further configured to receive and output the prompt message.

3. The system according to claim 1, wherein:
the vehicle server is further configured to send a warning message to the charging pile server if it is determined that, among all the candidate charging gun identifiers corresponding to the target parking space identifier, there are at least two that correspond to a second timestamp whose time difference with the first timestamp is less than the time threshold, wherein the warning message carries a to-be-verified charging gun identifier corresponding to each of the at least two second timestamps whose time difference is less than the time threshold;
the charging pile server is further configured to receive the warning message and send a prompt message, for reinserting charging gun, to a charging gun corresponding to the to-be-verified charging gun identifier; and
the charging gun corresponding to the to-be-verified charging gun identifier is configured to receive and output the prompt message.

4. The system according to claim 1, wherein:
the vehicle is specifically configured to send the target parking space identifier and location information of the parking space where the vehicle is located to the vehicle server; and
the vehicle server is further configured to receive the location information and determine a target parking lot corresponding to the location information, and if the target parking lot is in a currently stored parking lot whitelist, then the candidate charging gun identifiers corresponding to the target parking space identifier are determined based on the pre-stored correspondence between parking space identifiers and charging gun identifiers.

5. The system according to claim 1, wherein:
the vehicle server is further configured to, after determining each candidate charging gun identifier corresponding to the target parking space identifier, send a waiting-for-charge notification to the charging pile server, wherein the waiting-for-charge notification carries each candidate charging gun identifier; and
the charging pile server is further configured to receive the waiting-for-charge notification, and for all charging guns corresponding to the respective candidate charging gun identifiers, if any charging gun is detected as being inserted into one charging port, send a charging gun identifier of that charging gun and a corresponding second timestamp to the vehicle server.

6. The system according to claim 1, wherein:
the vehicle server is further configured to send a monitoring command to the vehicle to check whether the charging port is being inserted with a charging gun; and
the vehicle is further configured to receive the monitoring command and, if the charging port is detected as being inserted with a charging gun, send the first timestamp to the vehicle server.

7-12. (canceled)

13. A vehicle charging method, applied to a vehicle, comprising:
when an intention-to-charge event showing a charging port being unlocked is detected, sending a target parking space identifier of a parking space where the vehicle is located to a vehicle server; and
when the charging port is detected as being inserted with a charging gun, sending a first timestamp to the vehicle server, wherein the vehicle server determines candidate charging gun identifiers corresponding to the target parking space identifier based on a pre-stored correspondence between parking space identifiers and charging gun identifiers, the vehicle server receives charging gun identifiers and corresponding second timestamps sent by a charging pile server, and when the vehicle server determines that among the candidate charging gun identifiers corresponding to the target parking space identifier, there is only one that corresponds to a second timestamp whose time difference with the first timestamp is less than a time threshold, the vehicle server sends a charging command to the charging pile server, wherein the charging command carries a target charging gun identifier corresponding to a second timestamp whose time difference is less than the time threshold, the charging pile server sends a charging instruction to a charging gun corresponding to the target charging gun identifier, and the charging gun corresponding to the target charging gun identifier charges a vehicle connected to itself, wherein the charging gun identifiers and the corresponding second timestamps received by the vehicle server include a charging gun identifier of any charging gun and a corresponding second timestamp sent by the charging pile server when that charging gun is detected as being inserted into one charging port.

14. The method according to claim 13, further comprising:
receiving and outputting a prompt message, for reinserting charging gun, sent by the vehicle server.

15. The method according to claim 13, wherein sending the target parking space identifier of the parking space where the vehicle is located to the vehicle server comprises:
sending the target parking space identifier and location information of the parking space where the vehicle is located to the vehicle server.

16. The method according to claim 13, wherein after detecting the intention-to-charge event showing the charging port being unlocked, before the charging port is detected as being inserted with a charging gun and sending the first timestamp to the vehicle server, the method further comprises:
receiving a monitoring command, sent by the vehicle server, to check whether the charging port is being inserted with a charging gun.

17. A vehicle charging method, applied to a charging pile server, comprising:
when any charging gun is detected as being inserted into one charging port, sending a charging gun identifier of that charging gun and a corresponding second timestamp to a vehicle server, so that when the vehicle server determines that, among all candidate charging gun identifiers corresponding to a target parking space identifier, there is only one that corresponds to a second timestamp whose time difference with a first timestamp is less than a time threshold, a charging command is sent to the charging pile server, and the charging command carries a target charging gun identifier corresponding to a second timestamp whose time difference is less than the time threshold, wherein the target parking space identifier is a parking space identifier, of a parking space where a vehicle is located, sent by the vehicle to the vehicle server, and the first timestamp is sent by the vehicle to the vehicle server when a charging port is detected as being inserted with a charging gun; and
receiving the charging command and sending a charging instruction to a charging gun corresponding to the target charging connector identifier, so that the charging gun charges a vehicle connected to itself.

18. The method according to claim 17, further comprising:
receiving a warning message sent by the vehicle server, wherein the warning message is sent by the vehicle server when it is determined that, among all candidate charging gun identifiers corresponding to the target parking space identifier, there are at least two that correspond to a second timestamp whose time difference with the first timestamp is less than the time threshold, and the warning message carries a to-be-verified charging gun identifier corresponding to each of the at least two second timestamps whose time difference is less than the time threshold; and
sending a prompt message, for reinserting charging gun, to a charging gun corresponding a to-be-verified charging gun identifier, so that the charging gun receives and outputs the prompt message.

19. The method according to claim 17 wherein, when any charging gun is detected as being inserted into the charging port, before sending the charging gun identifier of the charging gun and the corresponding second timestamp to the vehicle server, the method further comprises:
receiving a waiting-for-charge notification sent by the vehicle server, wherein the waiting-for-charge notification carries each candidate charging gun identifier, and for a charging gun corresponding to each candidate charging gun identifier, performing a subsequent step of sending a charging gun identifier of that charging gun and a corresponding second timestamp to the vehicle server.

20-22. (canceled)

23. An electronic device, comprising at least a processor and a memory, wherein the processor is configured to implement the steps of the method according to claim 13 when executing a computer program stored in the memory.

24. (canceled)
